(19) United States
(12) Patent Application Publication
(10) Pub. No.: US 2026/0208692 A1
(43) Pub. Date: Jul. 23, 2026

(54) VEHICLE CONTROL SYSTEM, CONTROL METHOD, AND RECORDING MEDIUM

(71) Applicant: HONDA MOTOR CO., LTD., Tokyo (JP)

(72) Inventor: Toru Kitajima, Tokyo (JP)

(21) Appl. No.: 19/419,929

(22) Filed: Dec. 15, 2025

(30) Foreign Application Priority Data
Jan. 23, 2025 (JP) 2025-009774

(51) Int. Cl. B60R 25/20; B60R 25/104; B60R 25/31

(52) U.S. Cl. CPC B60R 25/20; B60R 25/104; B60R 25/31

(57) ABSTRACT

A vehicle control system of one aspect includes: a first control unit that controls a modification of a target vehicle state performed by a target device included in a vehicle; and a second control unit that sets an operation mode of an alarm that is based on a change of the target vehicle state and performed by an alarm device included in the vehicle, in accordance with a control situation of the modification of the target vehicle state by the first control unit.

### INCORPORATION BY REFERENCE

The present application claims priority under 35 U.S.C. § 119 to Japanese Patent Application No.2025-009774 filed on Jan. 23, 2025. The content of the application is incorporated herein by reference in its entirety.

### BACKGROUND OF THE INVENTION

### Field of the Invention

The present disclosure relates to a vehicle control system, a control method, and a recording medium.

### Description of the Related Art

Conventionally, in a vehicle parked with a security function being activated, when a change of a vehicle height is detected because an air suspension is activated or the like, a security alarm (hereinafter “alarm”) may be issued.

Regarding such issuance of an alarm, Chinese Patent Application Publication No. 116278569 discloses the following related art. That is, in an overheat protection control method for a vehicle in which, in order to prevent compressor overheat of the air suspension, a compressor is controlled to automatically stop at the time of overheat and to move again after being cooled, an alarm is prevented from being sounded at the time of overheat to prevent a user from feeling bothered.

However, the related art described above has a problem in that the alarm may be issued even when the vehicle height changes along with automatic adjustment by the air suspension such as automatic adjustment to a vehicle height suitable for a loading weight or the physique of the user at the time of loading or getting on and off. Such automatic adjustment is performed under user recognition such as at the time of loading or getting on and off, and hence the alarm due to the automatic adjustment is an excessive alarm for the user, and causes the user to feel bothered.

The present invention has been made in view of the above-mentioned problem, and has an object to suppress issuance of an excessive alarm due to automatic adjustment of a vehicle state.

### SUMMARY OF THE INVENTION

One aspect for achieving the above-mentioned object resides in a vehicle control system including: a first control unit that controls a modification of a target vehicle state performed by a target device included in a vehicle; and a second control unit that sets an operation mode of an alarm that is based on a change of the target vehicle state and performed by an alarm device included in the vehicle, in accordance with a control situation of the modification of the target vehicle state by the first control unit.

According to the above-mentioned one aspect, it is possible to suppress issuance of an excessive alarm due to the automatic adjustment of the vehicle state.

### BRIEF DESCRIPTION OF THE DRAWINGS

FIG. 1 is a block diagram illustrating a configuration example of a vehicle control system according to one embodiment;

FIG. 2 is an explanatory view illustrating an example of area sections of a host vehicle to which the vehicle control system according to the one embodiment is mounted;

FIG. 3 is an explanatory view illustrating a timing example regarding switching of an alarm mode;

FIG. 4 is a flowchart illustrating an operation example of the vehicle control system according to the one embodiment;

FIG. 5 is a flowchart illustrating an operation example of the vehicle control system according to the one embodiment;

FIG. 6 is a flowchart illustrating an operation example of the vehicle control system according to the one embodiment;

FIG. 7 is a flowchart illustrating an operation example of the vehicle control system according to the one embodiment;

FIG. 8 is a flowchart illustrating an operation example of the vehicle control system according to the one embodiment;

FIG. 9 is a flowchart illustrating an operation example of the vehicle control system according to the one embodiment;

FIG. 10 is a flowchart illustrating an operation example of the vehicle control system according to the one embodiment;

FIG. 11 is a flowchart illustrating an operation example of the vehicle control system according to the one embodiment; and

FIG. 12 is an explanatory view illustrating a case in which a safe mode of a battery is canceled in the vehicle control system according to the one embodiment.

### DETAILED DESCRIPTION OF THE INVENTION

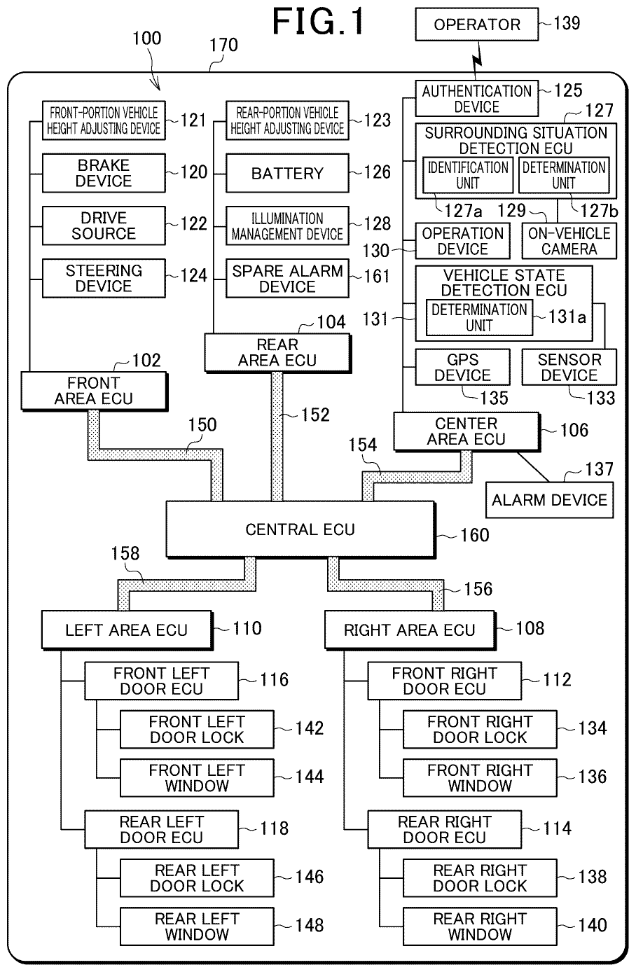

Hereinafter, a vehicle control system according to the present embodiment is described with reference to the drawings. FIG. 1 is a block diagram illustrating a configuration example of a vehicle control system according to one embodiment.

As illustrated in FIG. 1, a vehicle control system 100 is configured by connecting a plurality of control units that control an operation of a vehicle so as to be communicable with each other. In the present embodiment, the above-mentioned control units are ECUs (Electronic Control Units) (computers).

Specifically, the vehicle control system 100 is mounted on a host vehicle 170, and includes a front area ECU 102, a rear area ECU 104, a center area ECU 106, a right area ECU 108, and a left area ECU 110. The front area ECU 102, the rear area ECU 104, the center area ECU 106, the right area ECU 108, and the left area ECU 110 are control devices that respectively control a plurality of control targets mounted on the host vehicle 170.

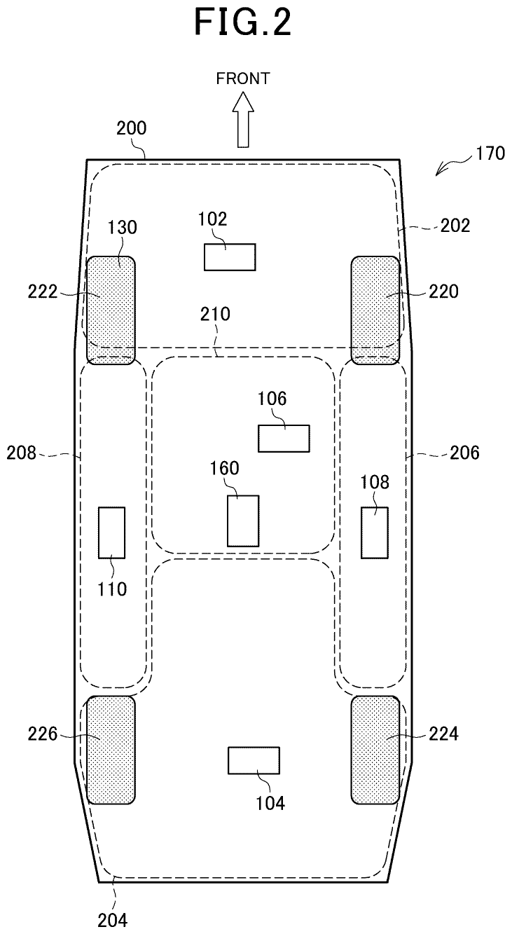

FIG. 2 is a view illustrating an example of area sections of a vehicle body 200 of the host vehicle 170. FIG. 2 illustrates the vehicle body 200 assuming a direction indicated by the white arrow in the illustration as front. As illustrated in FIG. 2, the vehicle body 200 is divided into, for example, a front area 202, a rear area 204, a right area 206, a left area 208, and a center area 210.

The front area 202 is a vehicle body region including portions of front wheels 220 and 222. The rear area 204 is a vehicle body region on the lower half of the illustration with respect to substantially the center of the vehicle body 200. The right area 206 is a vehicle body region sandwiched between the front wheel 220 and a rear wheel 224 on the right side of the illustration of the vehicle body 200. The left area 208 is a vehicle body region sandwiched between the front wheel 222 and a rear wheel 226 on the left side of the illustration. The center area 210 is a region at the vehicle body center surrounded by those areas.

The front area ECU 102, the rear area ECU 104, the center area ECU 106, the right area ECU 108, and the left area ECU 110 are each provided in each of the divided areas described above. That is, the front area ECU 102 is provided in the front area 202. The rear area ECU 104 is provided in the rear area 204. The center area ECU 106 is provided in the center area 210. The right area ECU 108 is provided in the right area 206. The left area ECU 110 is provided in the left area 208.

For example, the front area ECU 102 controls operations of a brake device 120 (computer), a front-portion vehicle height adjusting device 121, a drive source 122 including an internal combustion engine, a motor, a power generator, and the like, and a steering device 124 (computer), which are control targets mounted in the front area 202 of the host vehicle 170. The front-portion vehicle height adjusting device 121 is an air suspension mechanism or the like provided on the front wheels 220 and 222 in the front area 202 of the host vehicle 170. This front-portion vehicle height adjusting device 121 is an example of a target device that modifies a state of the host vehicle 170.

The rear area ECU 104 controls operations of a rear-portion vehicle height adjusting device 123, a battery 126 connected to the drive source 122 or the like, an illumination management device 128 (computer) that manages on and off of a light such as a direction indicator lamp, a reversing lamp, a license plate lamp, a tail lamp, and the like, and a spare alarm device 161, which are control targets mounted in the rear area 204. The rear-portion vehicle height adjusting device 123 is an air suspension mechanism or the like provided on the rear wheels 224 and 226 in the rear area 204 of the host vehicle 170. This rear-portion vehicle height adjusting device 123 is an example of the target device that modifies the state of the host vehicle 170.

The battery 126 is an example of a battery device that performs power supply to the host vehicle 170, and supplies power to various pieces of on-vehicle equipment such as the ECUs and an alarm device 137 in addition to the drive source 122. The spare alarm device 161 is a lighting device (computer) that turns on a hazard lamp or a sound emitting device that emits a warning sound, and emits an alarm independent of the alarm device 137 by an internal battery. Specifically, the spare alarm device 161 emits the alarm when a signal from the battery 126 (for example, power of 12 V supplied to various pieces of on-vehicle equipment) is interrupted under control of the rear area ECU 104 with the power of the internal battery. This alarm of the spare alarm device 161 makes it possible to prevent the battery 126 from being stolen in the host vehicle 170.

The center area ECU 106 controls operations of an authentication device 125 (computer), a surrounding situation detection ECU 127, an operation device 130, a vehicle state detection ECU 131, a GPS device 135, and the alarm device 137, which are control targets mounted in the center area 210.

The authentication device 125 authenticates an operator 139 by communication (for example, near field communication) with the operator 139 such as a smart key and a smart phone associated with the host vehicle 170. The authentication device 125 is an example of an authentication unit.

The surrounding situation detection ECU 127 is connected to an on-vehicle camera 129, and detects a person present around the host vehicle 170 based on an image taken by the on-vehicle camera 129. The surrounding situation detection ECU 127 is an example of a vehicle surrounding situation detection unit. Specifically, the surrounding situation detection ECU 127 includes an identification unit 127a and a determination unit 127b.

The identification unit 127a is a processing unit that identifies the person detected based on the image taken by the on-vehicle camera 129. Specifically, the identification unit 127a uses a publicly-known image recognition technology to compare an image region of the person detected by the image taken by the on-vehicle camera 129 with an image of a person stored in advance in a memory or the like, to thereby identify the detected person. In this case, the image of the person stored in advance in the memory or the like includes, in addition to an image of a user (for example, an owner of the host vehicle 170) that carries the operator 139 associated with the host vehicle 170, an image of a person taken by the on-vehicle camera 129 that takes an image inside a vehicle cabin of the host vehicle 170, that is, an image of a person on board the host vehicle 170. Accordingly, the identification unit 127a can identify whether or not the detected person is a person having a history of being on board the host vehicle 170.

The determination unit 127b is a processing unit that determines whether or not an abnormality has occurred based on the identification result of the identification unit 127a. Specifically, when a target person other than the user carrying the operator 139 or a person on board the host vehicle 170 is detected based on the identification result of the identification unit 127a, the determination unit 127b determines whether or not an abnormality corresponding to an alarm target has occurred based on a threat level of the target person. When the determination unit 127b determines that an abnormality corresponding to an alarm target has occurred, the determination unit 127b outputs an abnormality signal to another control unit such as the center area ECU 106.

For example, the determination unit 127b obtains a time in which the target person is wandering around the host vehicle 170 based on a time in which the image region of the target person is detected from the taken image. Further, the determination unit 127b obtains a distance or the like of the target person approaching the vicinity of the driver's seat of the host vehicle 170 based on the position, the size, and the like of the image region of the target person in the taken image. The determination unit 127b uses the time, the distance, or the like obtained as described above as an index value indicating the threat level of the target person with respect to the host vehicle 170. When this threat level is higher than a predetermined threshold value, the determination unit 127b determines that the target person is causing an abnormality (for example, theft or damage) corresponding to an alarm target to the host vehicle 170.

The operation device 130 is operation equipment on which the user performs operation, such as an accelerator pedal, a brake pedal, a steering wheel, and a shift lever. The center area ECU 106 controls operations such as signal reception from those pieces of operation equipment.

The vehicle state detection ECU 131 is connected to a sensor device 133, and detects the state of the host vehicle 170 based on a measurement result of the sensor device 133. The vehicle state detection ECU 131 is an example of a vehicle state detection unit. The vehicle state detection ECU 131 includes a determination unit 131a.

The sensor device 133 is, for example, an ultrasonic sensor that detects an object present around the host vehicle 170, a tilt sensor that detects the tilt of the host vehicle 170, or the like. As described above, the sensor device 133 may be any sensor as long as the sensor measures the state of the host vehicle 170 such as a situation around the host vehicle 170 and a tilt state of the host vehicle 170.

The determination unit 131a determines whether or not the host vehicle 170 is brought to an abnormality state corresponding to an alarm target based on the state of the host vehicle 170 acquired by the sensor device 133. For example, the determination unit 131a determines that the host vehicle 170 is brought to an abnormality state corresponding to an alarm target when a variation amount per unit time of the state of the host vehicle 170 (for example, a distance from an object present around the host vehicle 170 or the tilt of the host vehicle 170) becomes equal to or larger than a predetermined threshold value. When the determination unit 131a determines that the host vehicle 170 is brought to an abnormality state corresponding to an alarm target, the determination unit 131a transmits an abnormality signal to another control unit such as the center area ECU 106.

The GPS device 135 acquires a present position (vehicle position) of the host vehicle 170 based on a signal from a GPS (Global Positioning System) satellite. The GPS device 135 is an example of a position information acquisition unit. The GPS device 135 notifies another control unit such as the center area ECU 106 of the acquired vehicle position.

The alarm device 137 is a lighting device or the like that turns on a hazard lamp or a sound emitting device that emits a warning sound. The activation of the alarm device 137 such as the emission of the warning sound and the turning on of the hazard lamp is controlled by the center area ECU 106. It is to be noted that the alarm device 137 may be configured not only to issue an alarm by sound or light but also to issue an alarm to the operator 139 or the like via a communication network such as a wireless LAN.

The right area ECU 108 controls, via a front right door ECU 112 and a rear right door ECU 114 that respectively control operations of a front right door and a rear right door, a locking/unlocking operation of a front right door lock 134 mounted in the right area 206 and an opening/closing operation of a front right window 136, and a locking/unlocking operation of a rear right door lock 138 and an opening/closing operation of a rear right window 140. Further, the left area ECU 110 controls, via a front left door ECU 116 and a rear left door ECU 118 that respectively control operations of a front left door and a rear left door, a locking/unlocking operation of a front left door lock 142 mounted in the left area 208 and an opening/closing operation of a front left window 144, and a locking/unlocking operation of a rear left door lock 146 and an opening/closing operation of a rear left window 148.

The vehicle control system 100 further includes a central ECU 160. The central ECU 160 is connected by communication cables 150, 152, 154, 156, and 158 such as CAN (Controller Area Network) buses to the respective area ECUs (the front area ECU 102, the rear area ECU 104, the center area ECU 106, the right area ECU 108, and the left area ECU 110) and devices connected to the respective area ECUs so as to be communicable with each other.

The central ECU 160 gives an operation instruction to the front area ECU 102, the rear area ECU 104, the center area ECU 106, the right area ECU 108, and the left area ECU 110 to cause, for example, a plurality of control targets to perform cooperative operations as targets, and an operation instruction based on a user operation input. The central ECU 160 is a control unit that is in a higher level than the front area ECU 102, the rear area ECU 104, the center area ECU 106, the right area ECU 108, and the left area ECU 110. The central ECU 160 manages a control operation for the control target to be performed by each area ECU and gives settings and instructions required for the control operation.

For example, the central ECU 160 calculates a steering angle, drive source output, drive force distribution, a brake operation amount, and the like for achieving a vehicle behavior corresponding to steering, an accelerator operation, or a pedal operation of the user, and transmits the calculated result to each area ECU. In each area ECU, an operation amount for a corresponding sub-system, actuator, or the like is calculated for drive so that the vehicle behavior desired by the user is achieved. Further, the central ECU 160 instructs the front area ECU 102 and the rear area ECU 104 to perform cooperative operations of the brake device 120, the drive source 122, and the battery 126 in order to perform a regenerative braking operation, an acceleration operation, or appropriate charging and discharging (for example, in consideration of a battery life) of the battery 126 depending on the SOC (State Of Charge) of the battery 126. Further, operations for automatic driving and obstacle avoidance may be performed under the instruction of the central ECU 160.

Further, the central ECU 160 notifies, when the SOC of the battery 126 becomes less than a predetermined threshold value, in order to protect the battery 126, each area ECU of a control instruction signal for giving an instruction to shift to a safe mode in which power supply of the battery 126 is stopped. The rear area ECU 104 that has received the control instruction signal for giving an instruction to shift to the safe mode causes the battery 126 to shift to the safe mode in which the power supply to the host vehicle 170 is stopped. Further, while the rear area ECU 104 causes the battery 126 to shift to the safe mode, the rear area ECU 104 sets the operation mode of the spare alarm device 161 to an alarm disabled mode in which the alarm by the spare alarm device 161 is disabled. This makes it possible to suppress issuance of an alarm of the spare alarm device 161 triggered by interruption of the power supply from the battery 126 due to the safe mode.

Further, the central ECU 160 transmits a control instruction signal for adjusting the state of the host vehicle 170 to each area ECU at a timing at which the user carrying the operator 139 gets on or off, a luggage is loaded, or the like or at a regular (for example, each period) adjustment timing of the host vehicle 170. In each area ECU, based on reception of the control instruction signal for adjusting the state of the host vehicle 170, the state of the host vehicle 170 is adjusted by operating its own equipment being the control target.

For example, the front area ECU 102 activates the front-portion vehicle height adjusting device 121 based on the reception of the control instruction signal for adjusting the state of the host vehicle 170 to perform vehicle height adjustment to bring the front portion of the host vehicle 170 to a predetermined vehicle height. Similarly, the rear area ECU 104 activates the rear-portion vehicle height adjusting device 123 based on the reception of the control instruction signal for adjusting the state of the host vehicle 170 to perform vehicle height adjustment to bring the rear portion of the host vehicle 170 to a predetermined vehicle height. It is to be noted that the adjustment of the state of the host vehicle 170 is not limited to the vehicle height adjustment of the host vehicle 170. For example, the adjustment of the state of the host vehicle 170 may be ventilation by opening an electric roof (not shown) under control of the center area ECU 106.

Further, when the central ECU 160 receives a lock operation or the like performed by the operator 139 associated with the authentication device 125, the central ECU 160 instructs each area ECU to start a security operation to activate a security function. In each area ECU, based on the instruction to start the security operation, a security operation of activating the alarm device 137 when an abnormality state corresponding to an alarm target is detected is started.

Specifically, the center area ECU 106 activates the alarm device 137 when receiving an abnormality signal corresponding to an abnormality state being an alarm target from the surrounding situation detection ECU 127 or the vehicle state detection ECU 131. This causes the alarm device 137 to issue occurrence of an abnormality being an alarm target in the host vehicle 170 as an alarm.

In this case, each ECU such as the center area ECU 106, the vehicle state detection ECU 131, and the surrounding situation detection ECU 127 sets the operation mode of the alarm that is based on the change of the state of the host vehicle 170, in accordance with a control situation of the modification of the target vehicle state performed by the central ECU 160.

Specifically, while the modification of the vehicle state is controlled by the central ECU 160, the center area ECU 106 sets the operation mode of the alarm to the alarm disabled mode in which the alarm by the alarm device 137 is disabled even when the vehicle state detection ECU 131 detects that the vehicle state is a predetermined alarm target state.

Further, while the modification of the vehicle state is controlled by the central ECU 160, the surrounding situation detection ECU 127 and the vehicle state detection ECU 131 may set the alarm disabled mode by preventing the determination units 127b and 131a from determining whether or not the state of the host vehicle 170 is detected as the alarm target state.

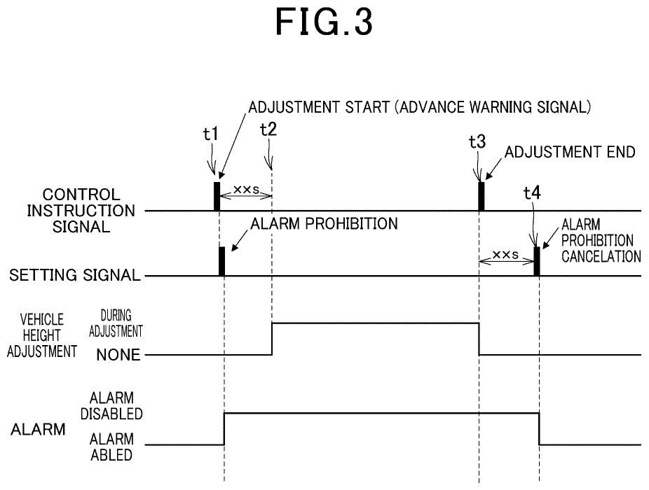

FIG. 3 is an explanatory view illustrating a timing example regarding switching of the alarm mode. As illustrated in FIG. 3, when each ECU such as the center area ECU 106, the vehicle state detection ECU 131, and the surrounding situation detection ECU 127 receives a control instruction signal (advance warning signal) for adjusting the state of the host vehicle 170 from the central ECU 160 (t1), each ECU outputs a setting signal for setting to the alarm disabled mode. As a result, in each ECU such as the center area ECU 106, the vehicle state detection ECU 131, and the surrounding situation detection ECU 127, the setting of the operation mode is modified from an alarm abled mode in which the alarm device 137 is activated based on the change of the state of the vehicle to the alarm disabled mode.

The front area ECU 102 and the rear area ECU 104 that have received the control instruction signal (advance warning signal) for adjusting the state of the host vehicle 170 perform vehicle height adjustment by the front-portion vehicle height adjusting device 121 and the rear-portion vehicle height adjusting device 123 after an elapse of a predetermined time (×× [s]) (t2). Then, based on reception of a control instruction signal indicating adjustment end, the front area ECU 102 and the rear area ECU 104 end the vehicle height adjustment by the front-portion vehicle height adjusting device 121 and the rear-portion vehicle height adjusting device 123 (t3). This control instruction signal indicating adjustment end is an example of an end signal. It is to be noted that this end signal may be, when the control instruction signal for adjusting the state of the host vehicle 170 is continuously output, interruption of this signal.

Each ECU such as the center area ECU 106, the vehicle state detection ECU 131, and the surrounding situation detection ECU 127 that has received the control instruction signal indicating the adjustment end outputs a setting signal for canceling the alarm prohibition caused by the alarm disabled mode (t4). As a result, in each ECU such as the center area ECU 106, the vehicle state detection ECU 131, and the surrounding situation detection ECU 127, the setting of the operation mode is modified from the alarm disabled mode to the alarm abled mode in which the alarm device 137 is activated based on the change of the state of the vehicle. It is to be noted that this output of the setting signal for canceling the alarm prohibition is preferably performed after an elapse of a predetermined time (×× [s]) as in the illustrated example instead of immediately after the control instruction signal indicating the adjustment end is received. This is because, when the alarm prohibition is canceled immediately after the control instruction signal is received, vibrations and the like caused by the vehicle height adjustment are not sufficiently attenuated and may be detected as an abnormality.

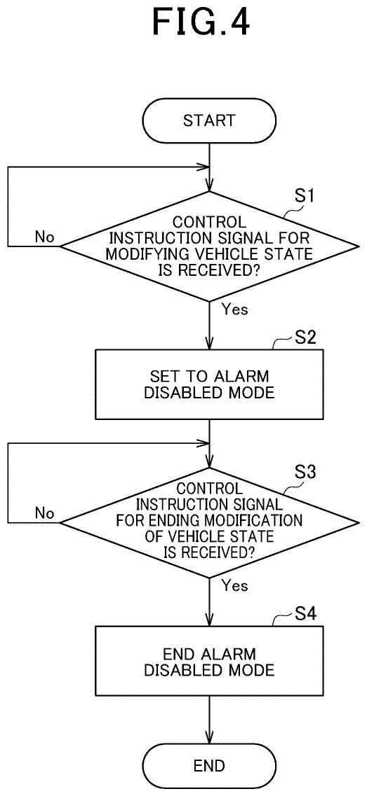

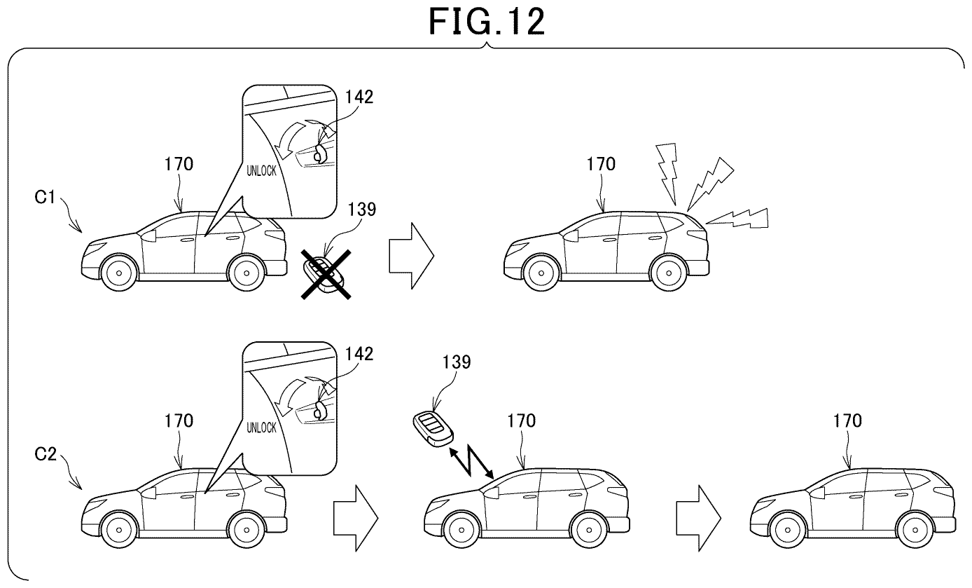

Here, the operation of the vehicle control system 100 described above will be described in detail with reference to FIG. 4 to FIG. 12. FIG. 4 to FIG. 11 are flowcharts illustrating operation examples of the vehicle control system 100 according to one embodiment. FIG. 12 is an explanatory view illustrating a case in which the safe mode of the battery is canceled in the vehicle control system according to the one embodiment.

As illustrated in FIG. 4, when the processing is started, each ECU such as the center area ECU 106, the vehicle state detection ECU 131, and the surrounding situation detection ECU 127 determines whether or not the control instruction signal for modifying the state of the host vehicle 170 has been received (S1). It is to be noted that, in FIG. 4, it is assumed that the time point at which the processing is started is after the start of the security operation is instructed from the central ECU 160, and the alarm abled mode is set in advance.

When no control instruction signal is received (S1: No), each ECU stands by for the processing. When the control instruction signal is received (S1: Yes), each ECU sets the operation mode to the alarm disabled mode (S2).

Then, each ECU determines whether or not the control instruction signal for ending the modification of the state of the host vehicle 170 has been received (S3). When no control instruction signal for ending the modification is received (S3: No), each ECU stands by for processing. When the control instruction signal for ending the modification is received (S3: Yes), each ECU ends the alarm disabled mode, and sets the operation mode to the alarm abled mode (S4).

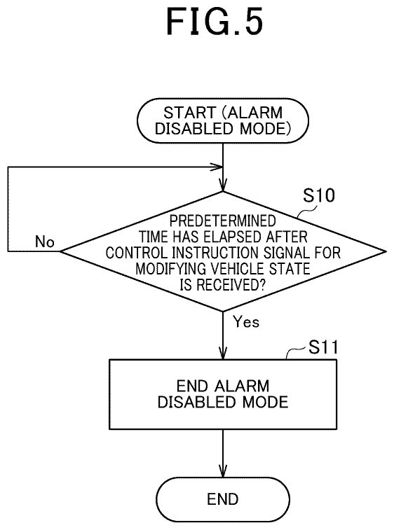

Next, description is given of a safety mechanism that cancels the setting of the alarm disabled mode. As illustrated in FIG. 5, when the processing is started (the alarm disabled mode is already set), each ECU such as the center area ECU 106, the vehicle state detection ECU 131, and the surrounding situation detection ECU 127 determines whether or not a predetermined time has elapsed after the control instruction signal for modifying the state of the host vehicle 170 is received (S10). In this case, as a time being a determination target, a time (for example, about one minute) estimated to be required to modify the state of the host vehicle 170 is set in advance in a memory or the like.

When the predetermined time has not elapsed (S10: No), each ECU stands by for processing. When the predetermined time has elapsed (S10: Yes), each ECU ends the alarm disabled mode, and sets the operation mode to the alarm abled mode (S11).

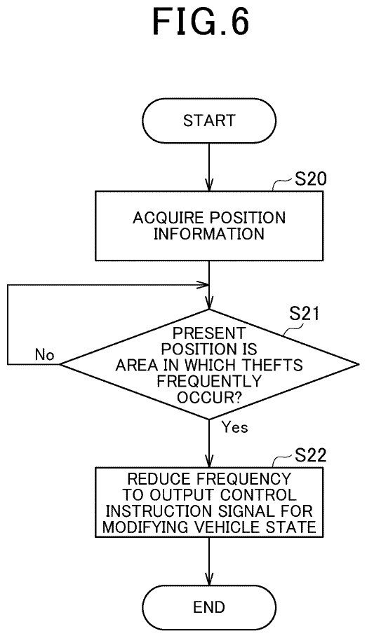

Next, description is given of a frequency in which the central ECU 160 performs regular adjustment (for example, each period) of the host vehicle 170. As illustrated in FIG. 6, the central ECU 160 acquires position information indicating the present position of the host vehicle 170 by the GPS device 135 (S20). Then, the central ECU 160 determines whether or not the present position of the host vehicle 170 is within a predetermined area (area in which thefts frequently occur) (S21). As an area being a determination target (area in which thefts frequently occur), information collected in advance by road-to-vehicle communication (V21), vehicle-to-vehicle communication (V2V), network communication (V2N), and the like is set in advance in a memory or the like.

When the present position of the host vehicle 170 is not in the predetermined area (area in which thefts frequently occur) (S21: No), the central ECU 160 stands by for processing. When the present position of the host vehicle 170 is in the predetermined area (area in which thefts frequently occur) (S21: Yes), the central ECU 160 reduces the frequency to output the control instruction signal for modifying the state of the host vehicle 170 (S22). Specifically, when the central ECU 160 normally outputs the control instruction signal every 24 hours to perform adjustment of the host vehicle 170, the central ECU 160 is caused to output the control instruction signal at a longer period such as every 36 hours or every 48 hours.

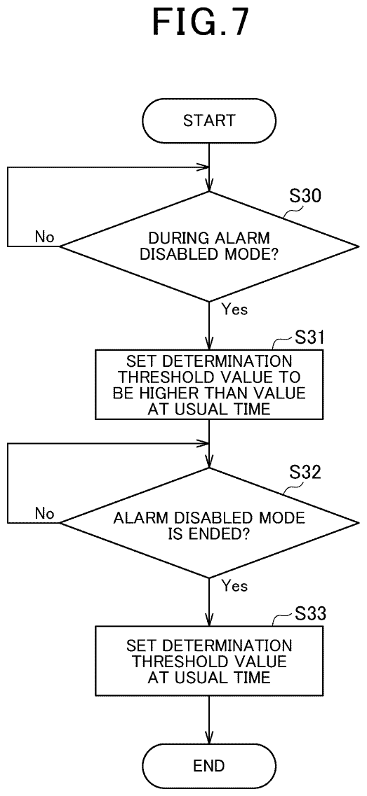

Next, description is given of raising a threshold value required for the determination units 127b and 131a to determine the abnormality state corresponding to the alarm target during the alarm disabled mode. As illustrated in FIG. 7, the surrounding situation detection ECU 127 and the vehicle state detection ECU 131 determine whether or not the operation mode is the alarm disabled mode (S30).

When the operation mode is not the alarm disabled mode (S30: No), the surrounding situation detection ECU 127 and the vehicle state detection ECU 131 stand by for processing. When the operation mode is the alarm disabled mode (S30: Yes), the surrounding situation detection ECU 127 and the vehicle state detection ECU 131 set a threshold value (determination threshold value) required for the determination units 127b and 131a to determine the abnormality state to a value higher than at the usual time (S31). In this case, the threshold value at the usual time is a threshold value used during the alarm abled mode.

Then, the surrounding situation detection ECU 127 and the vehicle state detection ECU 131 determine whether or not the alarm disabled mode is ended (S32). When the alarm disabled mode is not ended (S32: No), the surrounding situation detection ECU 127 and the vehicle state detection ECU 131 stand by for processing.

When the alarm disabled mode is ended (S32: Yes), the surrounding situation detection ECU 127 and the vehicle state detection ECU 131 return the threshold value (determination threshold value) required for the determination units 127b and 131a to determine the abnormality state to the setting at the usual time (S33).

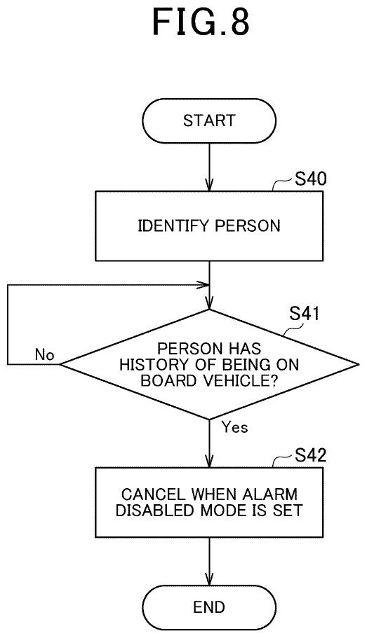

Next, description is given of the setting of the operation mode of the alarm based on a person detected by the surrounding situation detection ECU 127. As illustrated in FIG. 8, when the processing is started, the identification unit 127a of the surrounding situation detection ECU 127 identifies a person present around the host vehicle 170 (S40).

Then, the identification unit 127a determines whether or not the identified person is a person having a history of being on board the host vehicle 170 (S41). When the identified person is not a person having a history of being on board the host vehicle 170 (S41: No), the surrounding situation detection ECU 127 stands by for processing.

When the identified person is a person having a history of being on board the host vehicle 170 (S41: Yes), the surrounding situation detection ECU 127 notifies another ECU (such as the vehicle state detection ECU 131 or the center area ECU 106) that there is a person having a boarding history around the host vehicle 170. The surrounding situation detection ECU 127 and another ECU that has received the notification cancel the alarm disabled mode when the operation mode of the alarm is the alarm disabled mode and set the alarm abled mode (S42).

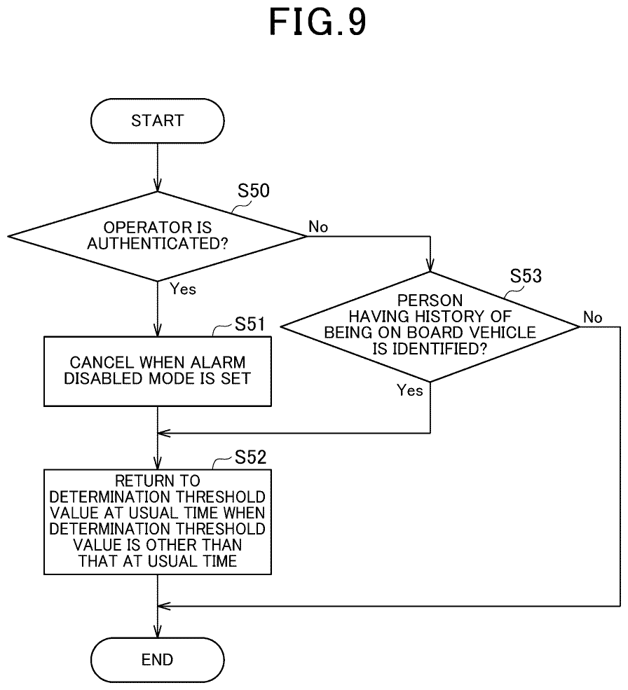

Next, description is given of the setting of the operation mode of the alarm based on the authentication of the operator 139. As illustrated in FIG. 9, each ECU such as the center area ECU 106, the vehicle state detection ECU 131, and the surrounding situation detection ECU 127 determines whether or not the operator 139 is authenticated by the authentication device 125 (S50).

When the operator 139 is authenticated (S50: Yes), each ECU cancels the alarm disabled mode when the operation mode of the alarm is the alarm disabled mode and sets the alarm abled mode (S51). Then, when the determination threshold value required for the determination units 127b and 131a to determine the abnormality state is a value other than that at the usual time, the surrounding situation detection ECU 127 and the vehicle state detection ECU 131 return the determination threshold value to that at the usual time (S52). Specifically, when the determination threshold value is higher than that at the usual time, the surrounding situation detection ECU 127 and the vehicle state detection ECU 131 do not use the high determination threshold value but return the determination threshold value to that at the usual time.

When the operator 139 is not authenticated (S50: NO), each ECU advances the process to S53. In S53, each ECU determines whether or not a person having a history of being on board the host vehicle 170 is identified based on the notification of the surrounding situation detection ECU 127. When no person having a history of being on board the host vehicle 170 is identified (S53: No), S52 is skipped and the processing is ended.

When a person having a history of being on board the host vehicle 170 is identified (S53: Yes), the surrounding situation detection ECU 127 and the vehicle state detection ECU 131 return the determination threshold value to that at the usual time when the determination threshold value required for the determination units 127b and 131a to determine the abnormality state is a value other than that at the usual time (S52).

As described above, with the operation mode of the alarm (alarm disabled mode/alarm abled mode) being set based on whether or not the operator 139 is authenticated, alarm setting corresponding to the presence or absence of a user carrying the operator 139 is allowed. For example, vehicle height adjustment or the like performed by the user carrying the operator 139 is intended by the user (for example, the security function is already canceled by the operator 139), and hence the alarm disabled mode is not required to be set.

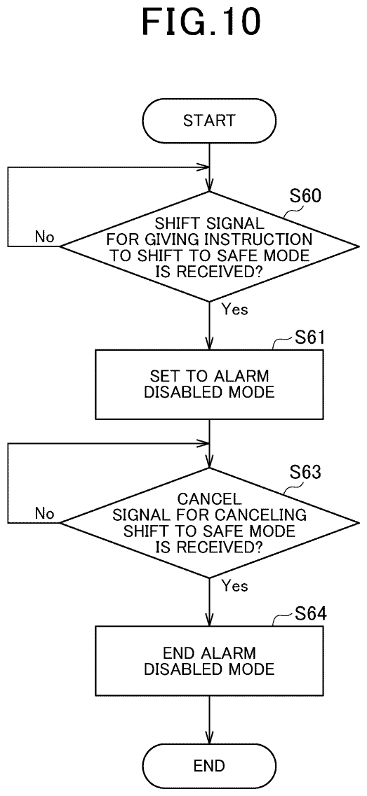

Next, description is given of an operation in which, while the battery 126 is shifted to the safe mode, the rear area ECU 104 sets the operation mode of the spare alarm device 161 to the alarm disabled mode. As illustrated in FIG. 10, when the processing is started, the rear area ECU 104 determines whether or not a shift signal (control instruction signal) for giving an instruction to shift to the safe mode is received (S60).

When no shift signal is received (S60: No), the rear area ECU 104 stands by for processing. When the shift signal is received (S60: Yes), the rear area ECU 104 sets the operation mode of the spare alarm device 161 to the alarm disabled mode (S61).

Then, the rear area ECU 104 determines whether or not a cancel signal (control instruction signal) for canceling the shift to the safe mode is received (S63). When no cancel signal is received (S63: No), the rear area ECU 104 stands by for processing. When the cancel signal is received (S63: Yes), the rear area ECU 104 cancels the alarm disabled mode of the spare alarm device 161 (S64).

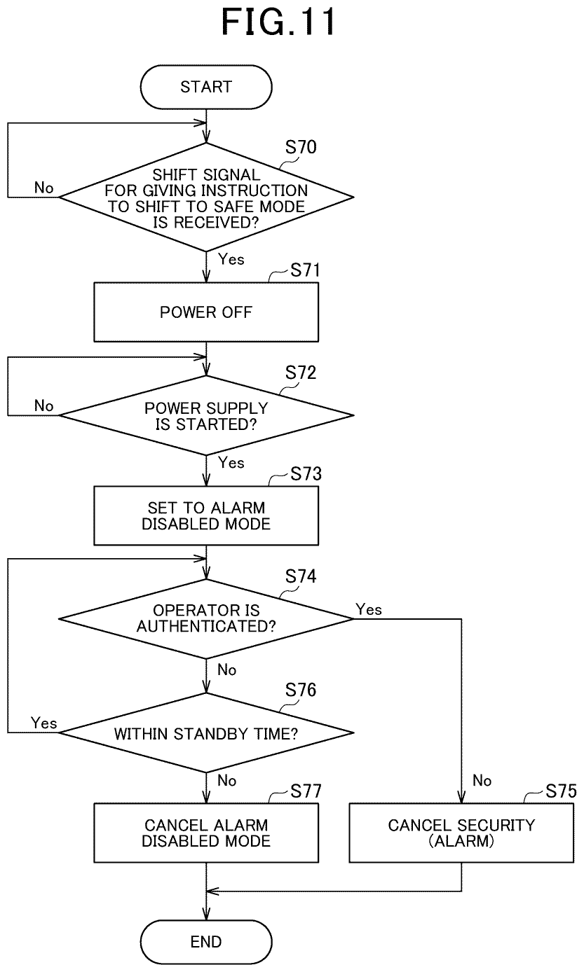

Next, description is given of an operation of the vehicle control system in a case in which, after the battery 126 is shifted to the safe mode, the safe mode is canceled. As illustrated in FIG. 11, when the processing is started, each ECU such as the center area ECU 106, the vehicle state detection ECU 131, and the surrounding situation detection ECU 127 determines whether or not the shift signal for giving an instruction to shift to the safe mode is received (S70).

When no shift signal is received (S70: No), each ECU stands by for processing. When the shift signal is received (S70: Yes), each ECU powers off various pieces of on-vehicle equipment (S71).

Then, each ECU determines whether or not power supply due to cancel of the safe mode of the battery 126 is started (S72). Examples of the start of the power supply include cancel of the safe mode based on a door open signal due to cancel of the front right door lock 134, the front left door lock 142, or the like. When the power supply is not started (S72: No), each ECU stands by for processing.

When the power supply is started (S72: Yes), each ECU performs initialization processing due to the start (restart) of the power supply. In this case, during a predetermined standby time (for example, during several seconds), each ECU sets the operation mode to the alarm disabled mode from the alarm abled mode in which the alarm device 137 is activated. Specifically, when the power supply is started, each ECU sets the operation mode to the alarm disabled mode (S73).

Then, each ECU determines whether or not the operator 139 is authenticated by the authentication device 125 (S74). When the operator 139 is authenticated (S74: Yes), each ECU cancels the security operation (alarm operation by the alarm device 137) (S75).

When the operator 139 is not authenticated (S74: No), each ECU determines whether or not it is within a predetermined standby time (S76). When it is within the predetermined standby time (S76: Yes), each ECU returns the process to S74, and continues the alarm disabled mode. As a result, in the vehicle control system 100, within the standby time, the alarm disabled mode is continued, and the alarm is not sounded due to opening of the door.

When it is not within the standby time (S76: No), each ECU cancels the alarm disabled mode, and sets the alarm abled mode in which the alarm device 137 is activated (S77). For example, as illustrated in cases C1 and C2 of FIG. 12, it is assumed that the power supply by the battery 126 is restarted by unlocking the front right door lock 142 and opening the door. At this time, as illustrated in case C1, in the vehicle control system 100, when the operator 139 is not authenticated within the standby time, the alarm is issued due to opening of the door. Further, as illustrated in case C2, in the vehicle control system 100, the alarm disabled mode is continued within the standby time, and hence the alarm is not immediately sounded due to the opening of the door. In addition, when the operator 139 is authenticated within the standby time, the security operation is canceled, and the alarm is not sounded similarly to the normal security clearance by the operator 139. As described above, in the vehicle control system, it is possible to suppress issuance of an unrequired alarm such as an alarm immediately sounded due to restart of power supply by the battery 126 due to opening of the door even though the operator 139 is carried.

As described above, the vehicle control system 100 includes a first control unit (central ECU 160) that controls a modification of a target vehicle state performed by a target device (front-portion vehicle height adjusting device 121 or rear-portion vehicle height adjusting device 123) included in the host vehicle 170, and a second control unit (center area ECU 106, vehicle state detection ECU 131, or the like) that sets an operation mode of an alarm that is based on a change of the target vehicle state and performed by the alarm device 137 included in the vehicle, in accordance with a control situation of the modification of the target vehicle state by the first control unit.

Accordingly, in the vehicle control system 100, it is possible to set the operation mode of the alarm that is based on the change of the target vehicle state to that corresponding to the control state of the modification of the target vehicle state, and it is possible to suppress issuance of an excessive alarm due to automatic adjustment of the vehicle state.

Further, the vehicle control system 100 includes the vehicle state detection ECU 131 that detects the target vehicle state. The second control unit sets, while the modification of the target vehicle state by the target device is controlled by the first control unit, the operation mode to the alarm disabled mode in which the alarm is not performed by the alarm device 137 even when the vehicle state detection ECU 131 detects that the target vehicle state is a predetermined alarm target state.

Accordingly, in the vehicle control system 100, while the modification of the target vehicle state is controlled, even when the predetermined alarm target state is detected, the alarm disabled mode in which the alarm is not performed by the alarm device 137 is set, and it is possible to suppress issuance of an alarm excessive for the user.

Further, the vehicle control system 100 includes a third control unit (center area ECU 106) that controls activation of the alarm device 137, and the second control unit sets, while the modification of the target vehicle state by the target device is controlled by the first control unit, the alarm disabled mode by stopping control of the activation of the alarm device 137 by the third control unit.

Accordingly, in the vehicle control system 100, while the modification of the target vehicle state by the target device is controlled, the alarm disabled mode is set by stopping the control of the activation of the alarm device 137, and it is possible to suppress issuance of an alarm excessive for the user.

Further, in the vehicle control system 100, the second control unit sets, while the modification of the target vehicle state by the target device is controlled by the first control unit, the alarm disabled mode by not performing determination on whether or not the target vehicle state has been detected to be the alarm target state by the vehicle state detection ECU 131.

Accordingly, in the vehicle control system 100, while the modification of the target vehicle state by the target device is controlled, the alarm disabled mode is set by not performing the determination on whether or not the target vehicle state has been detected to be the alarm target state, and it is possible to suppress issuance of an alarm excessive for the user.

Further, the third control unit sets, based on reception of an end signal indicating an end of the modification of the target vehicle state, an alarm abled mode in which the alarm device 137 is activated based on the change of the target vehicle state.

Accordingly, in the vehicle control system 100, when the modification of the target vehicle state is ended, the alarm abled mode in which the alarm device 137 is activated is promptly set, and thus it is possible to minimize the state in the alarm disabled mode. Accordingly, in the vehicle control system 100, it is possible to ensure anti-theft performance.

Further, the second control unit ends the alarm disabled mode when a predetermined time has elapsed from when the control of the modification of the target vehicle state is started.

Accordingly, in the vehicle control system 100, the alarm disabled mode can be ended even in a state in which, regardless of the end of the control of the modification of the target vehicle state, for example, the end signal for ending the control of the modification of the target vehicle state is not transmitted, and further this end signal cannot be received. Accordingly, in the vehicle control system 100, it is possible to ensure anti-theft performance.

Further, the vehicle control system 100 includes the GPS device 135 that acquires a present position of the host vehicle 170. The first control unit reduces, when the position of the host vehicle 170 is included in a predetermined area, a frequency to control the modification of the target vehicle state to be lower than a case in which the position of the host vehicle 170 is not included in the predetermined area.

Accordingly, in the vehicle control system 100, for example, in an area in which thefts frequently occur or the like, it is possible to decrease the frequency to control the modification of the target vehicle state to reduce the frequency of the opportunity to become the alarm disabled mode. Accordingly, in the vehicle control system 100, it is possible to ensure anti-theft performance.

Further, the vehicle control system 100 includes the surrounding situation detection ECU 127 that detects a person present around the host vehicle 170. The surrounding situation detection ECU 127 includes the identification unit 127a that identifies the detected person, and the determination unit 127b that determines whether or not an abnormality has occurred based on an identification result of the identification unit 127a. The surrounding situation detection ECU 127 modifies, while the alarm disabled mode is set, a threshold value required for the determination of the determination unit 127b to be higher than a case in which the alarm disabled mode is not set.

Accordingly, in the vehicle control system 100, while the alarm disabled mode is set, it is possible to make the issuance of the alarm based on the person present around the host vehicle 170 severer. Accordingly, in the vehicle control system 100, it is possible to ensure anti-theft performance.

Further, the second control unit does not perform setting to the alarm disabled mode when the identification unit 127a identifies a present having a history of being on board the host vehicle 170.

Accordingly, in the vehicle control system 100, when the person present around the host vehicle 170 is a person having a history of being on board the host vehicle 170, it is possible to not perform the setting to the alarm disabled mode. Accordingly, in the vehicle control system 100, it is possible to suppress issuance of an alarm that becomes excessive for the person having a history of being on board the host vehicle 170.

Further, the vehicle control system 100 includes the authentication device 125 that authenticates the operator 139 associated with the host vehicle 170. The second control unit does not perform setting to the alarm disabled mode when the authentication device 125 authenticates the operator 139.

Accordingly, in the vehicle control system 100, it is possible to suppress issuance of an alarm excessive for the user having the operator 139.

Further, the surrounding situation detection ECU 127 modifies, while the alarm disabled mode is set, a threshold value required for the determination of the determination unit 127b to be higher than a case in which the alarm disabled mode is not set, and does not modify the threshold value required for the determination of the determination unit 127b to be higher when the authentication device 125 authenticates the operator 139.

Accordingly, in the vehicle control system 100, while the alarm disabled mode is set, it is possible to make the issuance of the alarm based on a person present around the host vehicle 170 severer, and, when the user having the operator 139 is in the vicinity of the host vehicle 170, it is possible to prevent an alarm from being excessively issued to the user.

Further, when the authentication device 125 does not authenticate the operator 139, the surrounding situation detection ECU 127 does not modify the threshold value required for the determination of the determination unit 127b to be higher based on identification of the person having a history of being on board the host vehicle 170 by the identification unit 127a.

Accordingly, in the vehicle control system 100, when the person present around the host vehicle 170 is a person having a history of being on board the host vehicle 170, similarly to the user having the operator 139, it is possible to prevent an alarm from being excessively issued.

Further, the rear area ECU 104 sets, while the battery 126 is shifted to a safe mode in which the power supply to the host vehicle 170 is stopped based on a state of charge (SOC) of the battery 126, an alarm disabled mode in which an alarm is not performed by the spare alarm device 161.

Accordingly, in the vehicle control system 100, it is possible to suppress issuance of the alarm of the spare alarm device 161 triggered by interruption of the power supply caused when the battery 126 is shifted to the safe mode.

Further, each ECU sets, when the safe mode of the battery 126 is canceled and the power supply of the battery 126 is started, an alarm disabled mode in which the alarm is not performed by the alarm device 137 for a predetermined standby time. Each ECU cancels an operation related to the alarm of the alarm device 137 when the authentication device 125 authenticates the operator 139 within the standby time.

Accordingly, in the vehicle control system 100, when the safe mode of the battery 126 is canceled and the power supply of the battery 126 is started, it is possible to suppress issuance of an unrequired alarm by the alarm device 137.

It is to be noted that the above-mentioned embodiment is merely an example of the art in the present disclosure, and hence it is possible to make various modifications, replacements, additions, omissions, and the like in the scope of claims or in an equivalent scope thereof.

Further, the configurations of the units of the vehicle control system 100 illustrated in FIG. 1 are merely examples, and specific embodiments are not particularly limited. That is, it is not always required to mount hardware individually corresponding to each unit, and, as a matter of course, the functions of the units may be implemented by executing a program by one processor. Further, some functions to be implemented by software in the above-mentioned embodiment may be hardware, or some functions to be implemented by hardware may be software.

Further, step units of the operation in the ECU such as the central ECU 160, the center area ECU 106, or the like of FIG. 1 are divided in accordance with main process contents, and the present disclosure is not limited by the way to divide the process units or the names. The step units may be divided into a larger number of step units in accordance with the process contents. Further, one step unit may be further divided to include still more processes. Further, the order of steps may be switched as appropriate without departing from the spirit of the present disclosure.

Further, when the control method using a computer such as the central ECU 160, the center area ECU 106, and the like of the vehicle control system 100 described above is achieved through use of a processor, a program to be executed by the processor can be configured in a form of a recording medium or a transmission medium for transmitting the program. That is, the above-mentioned program can be implemented in a state in which the program is recorded in a portable information recording medium. Examples of the information recording medium include a magnetic recording medium such as a hard disk, an optical recording medium such as a CD, and a semiconductor storage device such as a USB (Universal Serial Bus) memory or an SSD (Solid State Drive), but other recording media can also be used.

### Configurations Supported by Above-Mentioned Embodiment

The above-mentioned embodiment is supported by the following configurations.

(Configuration 1) A vehicle control system including: a first control unit that controls a modification of a target vehicle state performed by a target device included in a vehicle; and a second control unit that sets an operation mode of an alarm that is based on a change of the target vehicle state and performed by an alarm device included in the vehicle, in accordance with a control situation of the modification of the target vehicle state by the first control unit.

With the vehicle control system of configuration 1, it is possible to set the operation mode of the alarm that is based on the change of the target vehicle state to correspond to the control state of the modification of the target vehicle state, and it is possible to suppress issuance of an excessive alarm due to the automatic adjustment of the vehicle state.

(Configuration 2) The vehicle control system according to configuration 1, further including a vehicle state detection unit that detects the target vehicle state, in which the second control unit sets, while the modification of the target vehicle state by the target device is controlled by the first control unit, the operation mode to an alarm disabled mode in which the alarm is not performed by the alarm device even when the vehicle state detection unit detects that the target vehicle state is a predetermined alarm target state.

With the vehicle control system of configuration 2, while the modification of the target vehicle state is controlled, even when the predetermined alarm target state is detected, the alarm disabled mode in which the alarm is not performed by the alarm device is set, and it is possible to suppress issuance of an alarm excessive for the user.

(Configuration 3) The vehicle control system according to configuration 2, further including a third control unit that controls activation of the alarm device, in which the second control unit sets, while the modification of the target vehicle state by the target device is controlled by the first control unit, the alarm disabled mode by stopping control of the activation of the alarm device by the third control unit.

With the vehicle control system of configuration 3, while the modification of the target vehicle state by the target device is controlled, the alarm disabled mode is set by stopping the control of the activation of the alarm device, and it is possible to suppress issuance of an alarm excessive for the user.

(Configuration 4) The vehicle control system according to configuration 2, in which the second control unit sets, while the modification of the target vehicle state by the target device is controlled by the first control unit, the alarm disabled mode by not performing determination on whether or not the target vehicle state has been detected to be the alarm target state by the vehicle state detection unit.

With the vehicle control system of configuration 4, while the modification of the target vehicle state by the target device is controlled, the alarm disabled mode is set by not performing determination on whether or not the target vehicle state has been detected to be the alarm target state, and it is possible to suppress issuance of an alarm excessive for the user.

(Configuration 5) The vehicle control system according to configuration 3, in which the third control unit sets, based on reception of an end signal indicating an end of the modification of the target vehicle state, an alarm abled mode in which the alarm device is activated based on the change of the target vehicle state.

With the vehicle control system of configuration 5, when the modification of the target vehicle state is ended, the alarm abled mode in which the alarm device is activated is promptly set, and hence it is possible to minimize the state in the alarm disabled mode.

(Configuration 6) The vehicle control system according to configuration 2, in which the second control unit ends the alarm disabled mode when a predetermined time has elapsed from when the control of the modification of the target vehicle state is started.

With the vehicle control system of configuration 6, the alarm disabled mode can be ended even in a state in which, regardless of the end of the control of the modification of the target vehicle state, for example, the end signal for ending the control of the modification of the target vehicle state is not transmitted, and further this end signal cannot be received.

(Configuration 7) The vehicle control system according to configuration 1, further including a position information acquisition unit that acquires a present vehicle position, in which the first control unit reduces, when the vehicle position is included in a predetermined area, a frequency to control the modification of the target vehicle state to be lower than a case in which the vehicle position is not included in the predetermined area.

With the vehicle control system of configuration 7, for example, in an area in which thefts frequently occur or the like, it is possible to decrease the frequency to control the modification of the target vehicle state to reduce the frequency of the opportunity to become the alarm disabled mode.

(Configuration 8) The vehicle control system according to configuration 2, further including a vehicle surrounding situation detection unit that detects a person present around the vehicle, in which the vehicle surrounding situation detection unit includes: an identification unit that identifies the detected person; and a determination unit that determines whether or not an abnormality has occurred based on an identification result of the identification unit, and in which the vehicle surrounding situation detection unit modifies, while the alarm disabled mode is set, a threshold value required for the determination to be higher than a case in which the alarm disabled mode is not set.

With the vehicle control system of configuration 8, while the alarm disabled mode is set, it is possible to perform issuance of an alarm based on a person present around the vehicle severer.

(Configuration 9) The vehicle control system according to configuration 8, in which the second control unit does not perform setting to the alarm disabled mode when the identification unit identifies a person having a history of being on board the vehicle.

With the vehicle control system of configuration 9, when the person present around the vehicle is a person having a history of being on board the vehicle, it is possible to prevent the alarm disabled mode from being set.

(Configuration 10) The vehicle control system according to configuration 2, further including an authentication unit that authenticates an operator associated with the vehicle, in which the second control unit does not perform setting to the alarm disabled mode when the authentication unit authenticates the operator.

With the vehicle control system of configuration 10, it is possible to suppress issuance of an alarm excessive for the user having the operator.

(Configuration 11) The vehicle control system according to configuration 10, further including a vehicle surrounding situation detection unit that detects a person present around the vehicle, in which the vehicle surrounding situation detection unit includes: an identification unit that identifies the detected person; and a determination unit that determines whether or not an abnormality has occurred based on an identification result of the identification unit, and in which the vehicle surrounding situation detection unit modifies, while the alarm disabled mode is set, a threshold value required for the determination to be higher than a case in which the alarm disabled mode is not set, and does not modify the threshold value to be higher when the authentication unit authenticates the operator.

With the vehicle control system of configuration 11, while the alarm disabled mode is set, the issuance of the alarm based on the person present around the vehicle is performed severer, and, when the user having the operator is in the vicinity of the vehicle, it is possible to prevent the alarm from being issued excessively for the user.

(Configuration 12) The vehicle control system according to configuration 11, in which, when the authentication unit does not authenticate the operator, the vehicle surrounding situation detection unit does not modify the threshold value to be higher based on identification of a person having a history of being on board the vehicle by the identification unit.

With the vehicle control system of configuration 12, when the person present around the vehicle is a person having a history of being on board the vehicle, it is possible to prevent the alarm from being excessively issued.

(Configuration 13) The vehicle control system according to configuration 1, further including: a battery device that performs power supply to the vehicle; a spare alarm device that emits an alarm independently of the alarm device; and a fourth control unit that operates the spare alarm device to emit the alarm based on stop of the power supply of the battery device, in which the fourth control unit sets, while the battery device is shifted to a safe mode in which the power supply to the vehicle is stopped by the first control unit based on a state of charge of the battery device, an alarm disabled mode in which the alarm is not performed by the spare alarm device.

With the vehicle control system of configuration 13, it is possible to suppress issuance of the alarm of the spare alarm device triggered by interruption of the power supply caused when the battery device is shifted to the safe mode.

(Configuration 14) The vehicle control system according to configuration 1, further including: a battery device that performs power supply to the vehicle; and an authentication unit that authenticates an operator associated with the vehicle, in which the second control unit sets, when a safe mode of the battery device is canceled and the power supply of the battery device is started, an alarm disabled mode in which the alarm is not performed by the alarm device for a predetermined standby time, and cancels an operation related to the alarm when the authentication unit authenticates the operator within the standby time.

With the vehicle control system of configuration 14, when the safe mode of the battery device is canceled and the power supply of the battery device is started, it is possible to suppress issuance of an unrequired alarm by the alarm device.

(Configuration 15) A control method for causing a computer to execute processing of: controlling a modification of a target vehicle state performed by a target device included in a vehicle; and setting an operation mode of an alarm that is based on a change of the target vehicle state and performed by an alarm device included in the vehicle, in accordance with a control situation of the modification of the target vehicle state.

With the control method of configuration 15, effects equivalent to those of configuration 1 described above are produced.

(Configuration 16) A non-transitory computer readable recording medium recording a program for causing a computer to execute processing of: controlling a modification of a target vehicle state performed by a target device included in a vehicle; and setting an operation mode of an alarm that is based on a change of the target vehicle state and performed by an alarm device included in the vehicle, in accordance with a control situation of the modification of the target vehicle state.

With the recording medium of configuration 16, effects equivalent to those of configuration 1 described above are produced.

### REFERENCE SIGNS LIST

100 . . . vehicle control system, 102 . . . front area ECU, 104 . . . rear area ECU, 106 . . . center area ECU, 108 . . . right area ECU, 110 . . . left area ECU, 112 . . . front right door ECU, 114 . . . rear right door ECU, 116 . . . front left door ECU, 118 . . . rear left door ECU, 120 . . . brake device, 121 . . . front-portion vehicle height adjusting device, 122 . . . drive source, 123 . . . rear-portion vehicle height adjusting device, 124 . . . steering device, 125 . . . authentication device, 126 . . . battery, 127 . . . surrounding situation detection ECU, 127a . . . identification unit, 127b . . . determination unit, 128 . . . illumination management device, 129 . . . on-vehicle camera, 130 . . . operation device, 131 . . . vehicle state detection ECU, 131a . . . determination unit, 132 . . . environment detection device, 133 . . . sensor device, 134 . . . front right door lock, 135 . . . GPS device, 136 . . . front right window, 137 . . . alarm device, 138 . . . rear right door lock, 139 . . . operator, 140 . . . rear right window, 142 . . . front left door lock, 144 . . . front left window, 146 . . . rear left door lock, 148 . . . rear left window, 150 . . . communication cable, 152 . . . communication cable, 154 . . . communication cable, 156 . . . communication cable, 158 . . . communication cable, 160 . . . central ECU, 161 . . . spare alarm device, 170 . . . host vehicle, 200 . . . vehicle body, 202 . . . front area, 204 . . . rear area, 206 . . . right area, 208 . . . left area, 210 . . . center area, 220 . . . front wheel, 222 . . . front wheel, 224 . . . rear wheel, 226 . . . rear wheel.

1. A vehicle control system comprising:
a first control unit that controls a modification of a target vehicle state performed by a target device included in a vehicle; and
a second control unit that sets an operation mode of an alarm that is based on a change of the target vehicle state and performed by an alarm device included in the vehicle, in accordance with a control situation of the modification of the target vehicle state by the first control unit.

2. The vehicle control system according to claim 1, further comprising a vehicle state detection unit that detects the target vehicle state,
wherein the second control unit sets, while the modification of the target vehicle state by the target device is controlled by the first control unit, the operation mode to an alarm disabled mode in which the alarm is not performed by the alarm device even when the vehicle state detection unit detects that the target vehicle state is a predetermined alarm target state.

3. The vehicle control system according to claim 2, further comprising a third control unit that controls activation of the alarm device,
wherein the second control unit sets, while the modification of the target vehicle state by the target device is controlled by the first control unit, the alarm disabled mode by stopping control of the activation of the alarm device by the third control unit.

4. The vehicle control system according to claim 2, wherein the second control unit sets, while the modification of the target vehicle state by the target device is controlled by the first control unit, the alarm disabled mode by not performing determination on whether or not the target vehicle state has been detected to be the alarm target state by the vehicle state detection unit.

5. The vehicle control system according to claim 3, wherein the third control unit sets, based on reception of an end signal indicating an end of the modification of the target vehicle state, an alarm abled mode in which the alarm device is activated based on the change of the target vehicle state.

6. The vehicle control system according to claim 2, wherein the second control unit ends the alarm disabled mode when a predetermined time has elapsed from when the control of the modification of the target vehicle state is started.

7. The vehicle control system according to claim 1, further comprising a position information acquisition unit that acquires a present vehicle position,
wherein the first control unit reduces, when the vehicle position is included in a predetermined area, a frequency to control the modification of the target vehicle state to be lower than a case in which the vehicle position is not included in the predetermined area.

8. The vehicle control system according to claim 2, further comprising a vehicle surrounding situation detection unit that detects a person present around the vehicle,
wherein the vehicle surrounding situation detection unit includes:
an identification unit that identifies the detected person; and
a determination unit that determines whether or not an abnormality has occurred based on an identification result of the identification unit, and
wherein the vehicle surrounding situation detection unit modifies, while the alarm disabled mode is set, a threshold value required for the determination to be higher than a case in which the alarm disabled mode is not set.

9. The vehicle control system according to claim 8, wherein the second control unit does not perform setting to the alarm disabled mode when the identification unit identifies a person having a history of being on board the vehicle.

10. The vehicle control system according to claim 2, further comprising an authentication unit that authenticates an operator associated with the vehicle,
wherein the second control unit does not perform setting to the alarm disabled mode when the authentication unit authenticates the operator.

11. The vehicle control system according to claim 10, further comprising a vehicle surrounding situation detection unit that detects a person present around the vehicle,
wherein the vehicle surrounding situation detection unit includes:
an identification unit that identifies the detected person; and
a determination unit that determines whether or not an abnormality has occurred based on an identification result of the identification unit, and
wherein the vehicle surrounding situation detection unit modifies, while the alarm disabled mode is set, a threshold value required for the determination to be higher than a case in which the alarm disabled mode is not set, and does not modify the threshold value to be higher when the authentication unit authenticates the operator.

12. The vehicle control system according to claim 11, wherein, when the authentication unit does not authenticate the operator, the vehicle surrounding situation detection unit does not modify the threshold value to be higher based on identification of a person having a history of being on board the vehicle by the identification unit.

13. The vehicle control system according to claim 1, further comprising:
a battery device that performs power supply to the vehicle;
a spare alarm device that emits an alarm independently of the alarm device; and
a fourth control unit that operates the spare alarm device to emit the alarm based on stop of the power supply of the battery device,
wherein the fourth control unit sets, while the battery device is shifted to a safe mode in which the power supply to the vehicle is stopped by the first control unit based on a state of charge of the battery device, an alarm disabled mode in which the alarm is not performed by the spare alarm device.

14. The vehicle control system according to claim 13, further comprising:
an authentication unit that authenticates an operator associated with the vehicle,
wherein the second control unit sets, when the safe mode of the battery device is canceled and the power supply of the battery device is started, an alarm disabled mode in which the alarm is not performed by the alarm device for a predetermined standby time, and cancels an operation related to the alarm when the authentication unit authenticates the operator within the standby time.

15. A control method for causing a computer to execute processing of:
controlling a modification of a target vehicle state performed by a target device included in a vehicle; and
setting an operation mode of an alarm that is based on a change of the target vehicle state and performed by an alarm device included in the vehicle, in accordance with a control situation of the modification of the target vehicle state.

16. A non-transitory computer readable recording medium recording a program for causing a computer to execute processing of:
controlling a modification of a target vehicle state performed by a target device included in a vehicle; and
setting an operation mode of an alarm that is based on a change of the target vehicle state and performed by an alarm device included in the vehicle, in accordance with a control situation of the modification of the target vehicle state.
